(19) United States
(12) Patent Application Publication
(10) Pub. No.: US 2021/0191490 A1
(43) Pub. Date: Jun. 24, 2021

(54) BALANCING POWER BETWEEN DISCRETE COMPONENTS IN A COMPUTE NODE

(71) Applicant: Intel Corporation, Santa Clara, CA (US)

(72) Inventors: Phani Kumar KANDULA, Bangalore (IN); Eric J. DEHAEMER, Shrewsbury, MA (US); Dorit SHAPIRA, Portland, OR (US); Ramkumar NAGAPPAN, Chandler, AZ (US); Vivek GARG, Folsom, CA (US); Fuat KECELI, Portland, OR (US); Mani PRAKASH, Austin, TX (US); David C. HOLCOMB, University Place, WA (US); Horthense D. TAMDEM, Portland, OR (US); Olivier FRANZA, Brookline, MA (US); Vjekoslav SVILAN, Tiburon, CA (US)

(21) Appl. No.: 17/191,564

(22) Filed: Mar. 3, 2021

(51) Int. Cl. G06F 1/324

(52) U.S. Cl. CPC G06F 1/324

(57) ABSTRACT

Methods and apparatus for balancing power between discrete components, such as processing units (e.g., CPUs) and accelerators in a compute node or platform. Power consumption of the compute platform is monitored to detect for conditions under which a threshold (e.g., power supply capacity threshold) is exceeded. In response, the operating frequencies of a processing unit and/or other platform components such as accelerators, are adjusted to reduce the power consumption of the platform to return below the threshold. Power limit biasing hints (scaling weights) are provided to platform components, along with a power violation index, which are used to adjust the operating frequencies of the platform components. Optionally, a processing unit can calculate the power violation index and the scaling weights and directly control the frequencies of itself and platform components. Embodiments of multi-socket platforms are also provided.

### BACKGROUND INFORMATION

To solve the next generation machine learning and high-performance computing problems, the industry is going towards heterogeneous computing with accelerators and processing units such as Central Processing Units (CPUs). To achieve maximum performance, the Thermal Design Power (TDP) for both the CPU and accelerators are increasing. Depending on the CPU to accelerator ratio, the overall power of the compute node is increasing as a consequence. This means the Power Supply Unit (PSU) for the node should be sized to support the sum of TDP's from all the components on the platform. However, depending on the workload behavior, not all platform components consume their TDP's at the same time. Some workloads are either CPU-centric or accelerator-centric from temporal distribution point of view.

Historically, power management in a compute node with various degrees of capabilities have been done with a Baseboard Management Controller (BMC), a Node Manager (NM), or a Data Center Manager (DCM). In all these cases, the response time to change/balance the power is in the 100 ms range, which is too slow to allow the platform to downsize the PSU. Thus, the PSU must be designed to handle the maximum TDP's of all the components in the node, which is expensive and a ‘over design’, since in practice, not all components are operated at maximum power at the same time most of the time.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a block diagram of a platform used to describe an overview of the power balancing approach disclosed herein;

FIG. 2 is a flowchart illustrating an example of a power balancing implementation, according to one embodiment.

FIG. 3 is a schematic diagram of a platform having an example configuration including two CPUs and six Accelerators;

FIG. 4 is a schematic diagram of a dual-socket platform configured to implement a balanced power management scheme in accordance with aspects of the techniques disclosed herein;

FIG. 5 is a graph illustrating changes in GPU, CPU, and power supply power levels;

FIG. 6 is a table illustrating various CPU and GPU power configurations; and

FIG. 7 is a diagram of a compute node that may be implemented with aspects of the embodiments described and illustrated herein.

### DETAILED DESCRIPTION

Embodiments of methods and apparatus for balancing power between discrete components in a compute node are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

For clarity, individual components in the Figures herein may also be referred to by their labels in the Figures, rather than by a particular reference number. Additionally, reference numbers referring to a particular type of component (as opposed to a particular component) may be shown with a reference number followed by “(typ)” meaning “typical.” It will be understood that the configuration of these components will be typical of similar components that may exist but are not shown in the drawing Figures for simplicity and clarity or otherwise similar components that are not labeled with separate reference numbers. Conversely, “(typ)” is not to be construed as meaning the component, element, etc. is typically used for its disclosed function, implement, purpose, etc.

An accordance with aspects of the embodiments disclosed herein, methods and apparatus for balancing power between discrete components, such as CPUs and accelerators in a compute node are provided. In one aspect, the techniques enable the sizing of a PSU to be optimized to support a higher TDP for the CPU's/Accelerators and implementing a power balancing scheme with a faster throughput. The solutions disclosed herein are not limited to CPU and Accelerators and may be applied to any discrete components on the platform including memory, fan, FPGA, CXL/PCIe devices or other devices accessed via fabrics or peripheral buses/interconnects, etc.

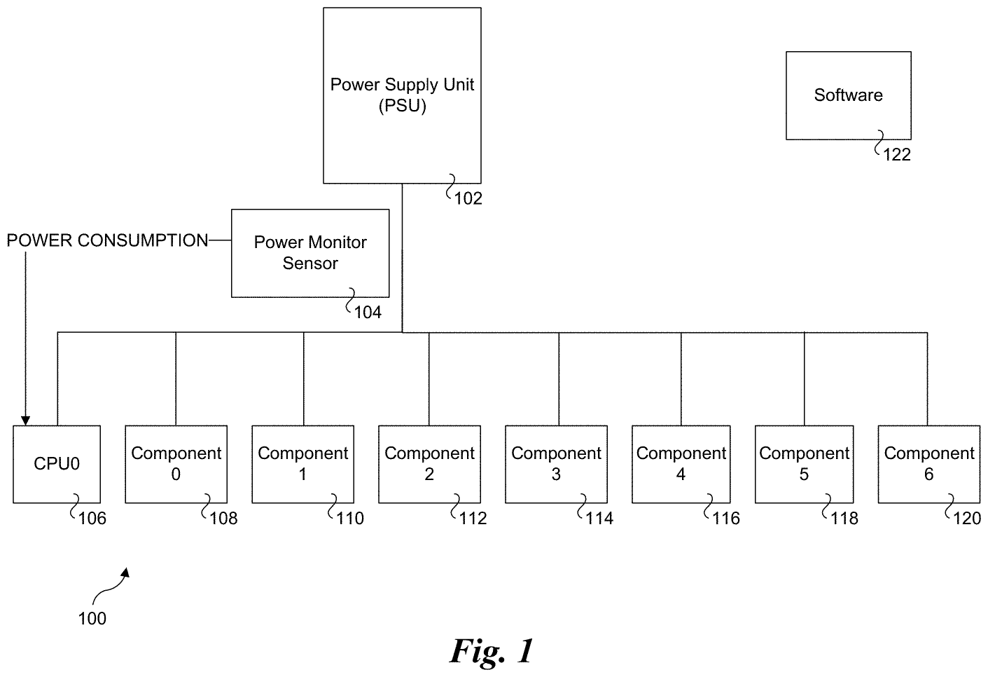

FIG. 1 shows an exemplary set of components of a platform 100 used to describe an overview of the power balancing approach. Platform 100 includes a power supply unit (PSU) 102, a power monitor sensor 104, a CPU 106 (also labeled CPU0), and seven variable frequency components 108, 110, 112, 114, 116, 118, and 120 (also labeled Component 0-6). Software 122 runs on CPU 106. Generally, variable frequency components 108, 110, 112, 114, 116, 118, and 120 may comprise CPUs, accelerators, and Other Processing Units (collectively termed XPUs) including one or more of Graphic Processor Units (GPUs) or General Purpose GPUs (GP-GPUs), Tensor Processing Units (TPUs), Data Processor Units (DPUs), Infrastructure Processing Units (IPUs), Artificial Intelligence (AI) processors or AI inference units and/or other accelerators, FPGAs and/or other programmable logic (used for compute purposes), network processors etc., that are enabled to adjust their operating frequency to increase or reduce their power consumption. In addition to the components shown, platform 100 would include additional components such as memory, peripheral devices, storage, etc., as will be recognized by those skilled in the art.

PSU 102 is used to provide power to a platform's components. Power monitor sensor 104 is used for monitoring the power consumption of the entire platform (or) power drawn from PSU 102 and for providing that information to one of the platform's CPU (CPU0 in this example). Software 122 is configured to dynamically or statically provide/adjust biasing hints that allows prioritization between platform components when power reduction is needed. The platform software may use either in-band or out-of-band mechanisms to communicate the parameters to applicable platform components.

Generally, power consumption is directly proportional to the operating frequency of the platform components. A common way to regulate to platform power constraints is to have the CPU(s) and other components, such as accelerators, modulate their frequency.

Determination of Power Limit Violation:

Under one embodiment, determination of power limit violations proceeds as follows. CPU0 continuously compares the platform's power consumption with PSU capability limit and produces a ‘Power Violation Index’ comprising a number from 0 to 1, where 0 means the power limit is not violated. Based on the magnitude of violation of power limit, the ‘Power Violation Index’ will get increased correspondingly. The ‘Power Violation Index’ is communicated to the platform components that are configured to vary their operating frequencies in view of the ‘Power Violation Index’ values they receive.

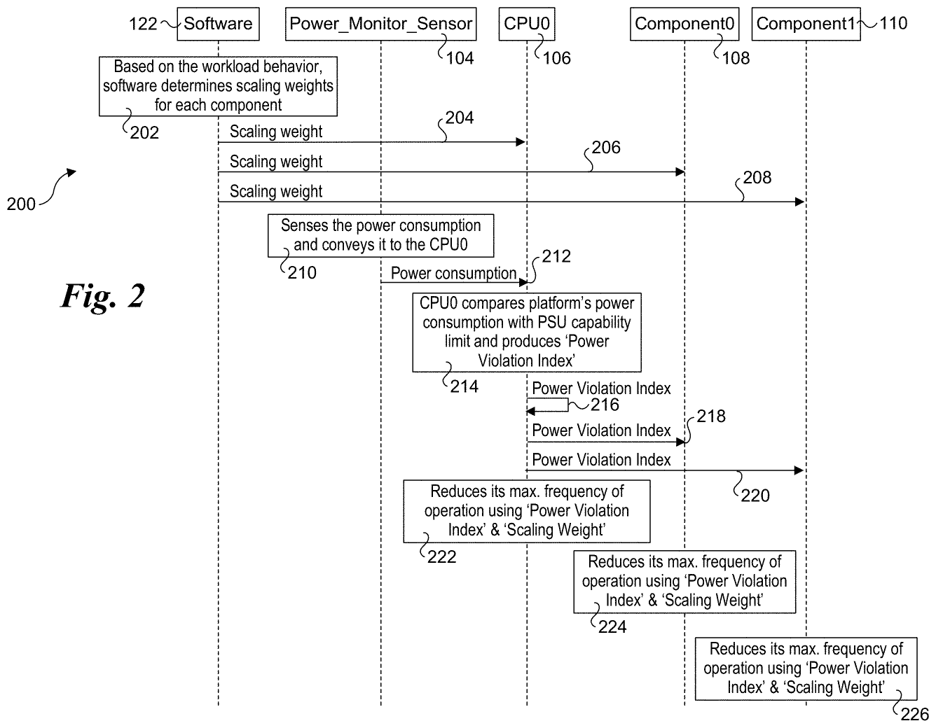

FIG. 2 shows a flowchart 200 illustrating an example of a power balancing implementation, according to one embodiment. The communication is between software 122, power monitor sensor 104, CPU0 (106), and components 108 and 110. As shown in a block 202, based on the workload behavior, software 122 determines scaling weights for each component. Software 122 sends scaling weights 204, 206, and 208 to CPU0, component 108, and component 110, respectively. As shown by a block 210, power monitor sensor 104 senses the power consumption of the platform components (collectively) or power drawn from PSU 102 and conveys it to CPU0, as depicted by power consumption signal 212.

In a block 214, CPU0 compares the platform's power consumption with the PSU capability limit and produces a ‘Power Violation Index’. Corresponding ‘Power Violation Index’ signals or messages 216, 218, and 220 are respectively sent from CPU0 to itself, component 108, and component 110.

As shown by block 222, CPU0 reduces it max. frequency of operation using the ‘Power Violation Index’ and ‘Scaling Weight’ CPU0 calculates and/or receives. (It is noted that for a single CPU platform, software 122 will be running on CPU0). Similarly, as shown by blocks 224 and 226, components 108 and 110 reduce their max. frequency of operation using the ‘Power Violation Index’ and ‘Scaling Weight’ they respectively receive.

Power Management with CPU0 Vs Legacy BMC Technology

As outlined herein, power management with embodiments disclosed herein are ˜10× faster than Legacy BMC technology. Generally, the speed increase is primarily due to two considerations: 1) The processing speed of a CPU is much faster than a BMC; and 2) there is no latency associated with transfer of platform control data from a BMC to the CPU. In addition, the power management scheme gives the user the choice of which component to throttle (CPU, Accelerator, or other components) and by how much. The following section presents details of these ‘biasing hints’ for power management.

Biasing Hints for Prioritizing ‘Throttle’ Between Different Components:

Software knowing the workload characteristic, provides a biasing hint to each component named ‘scaling weight’. In one embodiment, this is determined using the following formula:

Scaling weight of a component=(expected frequency reduction in percentage)/(expected frequency reduction when all components are given equal priority.)

This means if one component needs to be prioritized over another component, it will have lesser scaling weight compared to the other component.

Also, in some embodiments, software can instruct any component to ignore the ‘Power Violation Index’. This enables some components to be prioritized such that the power provided to those components is not throttled.

Frequency Reduction Done by Each Component to Reduce Power Consumption

In some embodiments, each component reduces its max. frequency of operation using the ‘Power Violation Index’ and ‘Scaling Weight” if it is not configured to ignore the ‘Power Violation Index’. In one embodiment the following formula is used:

Frequency Reduction=(Max. frequency of the component when not throttled)*(Power Violation Index)*(Scaling Weight)

Example Scenarios (Platform Setup)

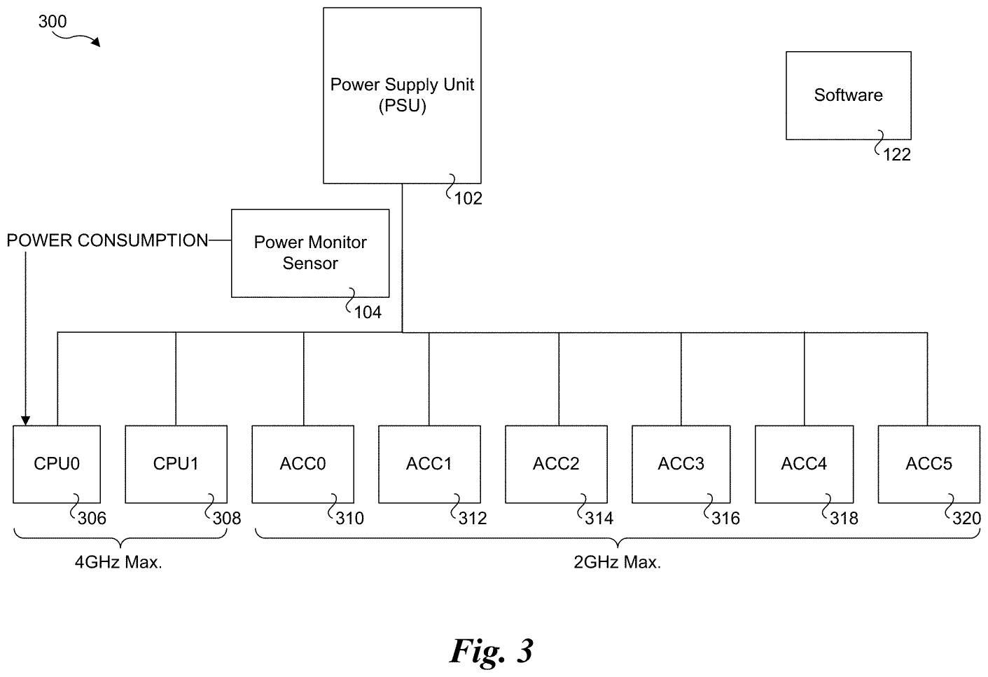

In the following scenarios, a platform 300 having an example configuration including two CPUs 306 and 308 (CPU0 and CPU1) and six Accelerators 310, 312, 314, 316, 318, and 320 (ACC0-5) is used, as shown in FIG. 3. The maximum frequency for a CPU is 4 GHz, while the maximum frequency for an Accelerator is 2 GHz. At one instance, assume the ‘Power Violation Index’ determined by CPU0 is 0.2.

Scenario 1 (all Components are Prioritized Equally)

Under a first scenario, all components are prioritized equally. In this case, scaling weight of all components will be 1. The Accelerators are GPUs. Accordingly:
The CPU max. frequency will be reduced to 4 Ghz*(1−0.2)=3.2 GHz
The GPU max. frequency will be reduced to 2 GHz*(1−0.2)=1.6 GHz

Scenario 2 (CPU is Prioritized Over GPU)

Under a second scenario, we want all power reduction to come from the Accelerators. In this case, the CPUs are configured to ignore the ‘Power Violation Index’. TABLE 1 represents the ‘scaling weights’ that are to be programmed and calculates the max. frequency of operation for each component.

TABLE 1

| Com- | | |
|---|---|---|
| ponent | Scaling Weight | Max. frequency of operation |
| CPU0 | NA | 4 GHz |
| CPU1 | NA | 4 GHz |
| ACC0 | 16.667/12.5 = 1.333 | 2 GHz*(1 - (0.2*1.333) = 1.47 GHz |
| ACC1 | 16.667/12.5 = 1.333 | 2 GHz*(1 - (0.2*1.333) = 1.47 GHz |
| ACC2 | 16.667/12.5 = 1.333 | 2 GHz*(1 - (0.2*1.333) = 1.47 GHz |
| ACC3 | 16.667/12.5 = 1.333 | 2 GHz*(1 - (0.2*1.333) = 1.47 GHz |
| ACC4 | 16.667/12.5 = 1.333 | 2 GHz*(1 - (0.2*1.333) = 1.47 GHz |
| ACC5 | 16.667/12.5 = 1.333 | 2 GHz*(1 - (0.2*1.333) = 1.47 GHz |

Scenario 3 (GPU is Prioritized Over CPU)

Under a third scenario, we want all power reduction to come from the CPUs. To obtain this result, the Accelerators are configured to ignore the ‘Power Violation Index’. TABLE 2 represents the ‘scaling weights’ that are to be programmed and calculates the max. frequency of operation for each component.

TABLE 2

| Com- | | |
|---|---|---|
| ponent | Scaling Weight | Max. frequency of operation |
| CPU0 | 50/12.5 = 4 | 4 GHz * (1 - (0.2*4)) = 0.8 GHz |
| CPU1 | 50/12.5 = 4 | 4 GHz * (1 - (0.2*4)) = 0.8 GHz |
| ACC0 | NA | 2 GHz |
| ACC1 | NA | 2 GHz |
| ACC2 | NA | 2 GHz |
| ACC3 | NA | 2 GHz |
| ACC4 | NA | 2 GHz |
| ACC5 | NA | 2 GHz |

Scenario 4 (CPU is Prioritized Over GPU—but not Fully)

Under a fourth scenario, we want frequency reduction from the CPU(s) to be 20% and Accelerators to be 80%. TABLE 3 shows the value of the ‘scaling weights’ that are to be programmed and calculates the max. frequency of operation for each component.

TABLE 3

| Com- | | |
|---|---|---|
| ponent | Scaling Weight | Max. frequency of operation |
| CPU0 | 10/12.5 = 0.8 | 4 GHz*(1-(0.2*0.8) = 3.36 GHz |
| CPU1 | 10/12.5 = 0.8 | 4 GHz*(1-(0.2*0.8) = 3.36 GHz |
| ACC0 | 13.333/12.5 = 1.067 | 2 GHz*(1-(0.2*1.067) = 1.57 GHz |
| ACC1 | 13.333/12.5 = 1.067 | 2 GHz*(1-(0.2*1.067) = 1.57 GHz |
| ACC2 | 13.333/12.5 = 1.067 | 2 GHz*(1-(0.2*1.067) = 1.57 GHz |
| ACC3 | 13.333/12.5 = 1.067 | 2 GHz*(1-(0.2*1.067) = 1.57 GHz |
| ACC4 | 13.333/12.5 = 1.067 | 2 GHz*(1-(0.2*1.067) = 1.57 GHz |
| ACC5 | 13.333/12.5 = 1.067 | 2 GHz*(1-(0.2*1.067) = 1.57 GHz |

Scenario 5 (all Components are Prioritized Differently)

Under a fifth scenarios, the components are prioritized with different levels. TABLE 4 shows the expected frequency reduction and the ‘scaling weights’ that are to be programmed and calculates the max. frequency of operation for each component.

TABLE 4

| | Frequency | | |
|---|---|---|---|
| | reduction | | |
| | expected | | |
| Com- | (all adds up- | | Max. frequency of |
| ponent | to 100%) | Scaling Weight | operation |
| CPU0 | 15% | 15/12.5 = 1.2 | 4 GHz*(1-(0.2*1.2) = |
| | | | 3.04 GHz |
| CPU1 | 10% | 10/12.5 = 0.8 | 4 GHz*(1-(0.2*0.8) = |
| | | | 3.36 GHz |
| ACC0 | 20% | 20/12.5 = 1.6 | 2 GHz*(1-(0.2*1.6) = |
| | | | 1.84 GHz |
| ACC1 | 5% | 5/12.5 = 0.4 | 2 GHz*(1-(0.2*0.4) = |
| | | | 1.57 GHz |
| ACC2 | 16% | 16/12.5 = 1.28 | 2 GHz*(1-(0.2*1.28) = |
| | | | 1.49 GHz |
| ACC3 | 12% | 12/12.5 = 0.96 | 2 GHz*(1-(0.2*0.96) = |
| | | | 1.62 GHz |
| ACC4 | 14% | 14/12.5 = 1.12 | 2 GHz*(1-(0.2*1.12) = |
| | | | 1.552 GHz |
| ACC5 | 8% | 8/12.5 = 0.64 | 2 GHz*(1-(0.2*0.64) = |
| | | | 1.74 GHz |

Multi-Socket Platforms

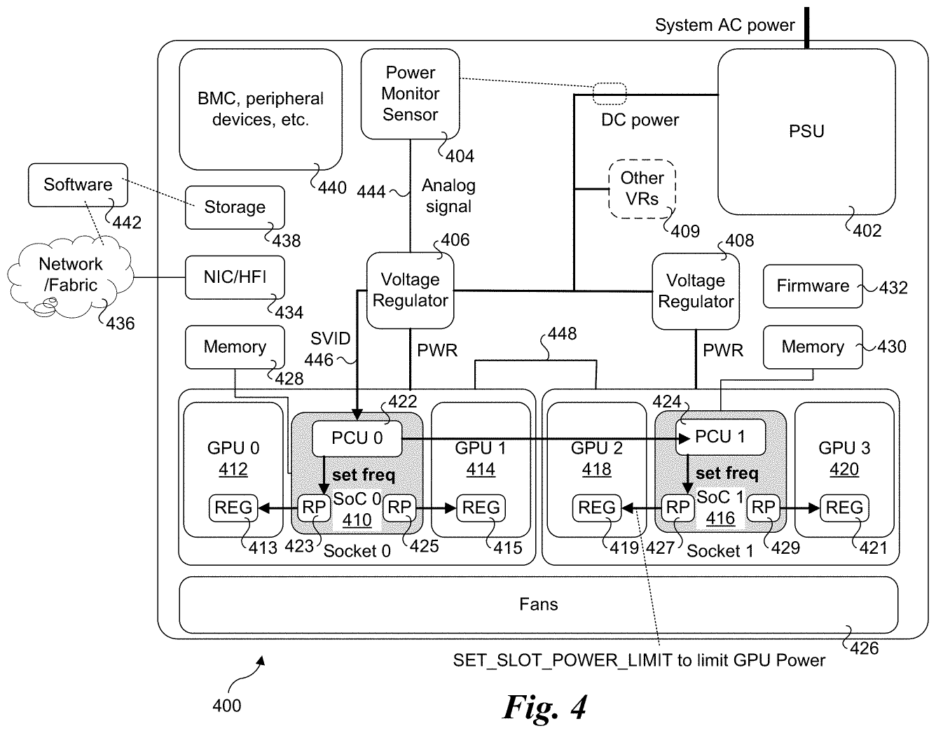

FIG. 4 shows a dual-socket platform 400 configured to implement a balanced power management scheme employing the techniques disclosed herein. The power components of platform 400 include a PSU 402, a power monitor sensor 404, voltage regulators 406, 408, and optional other voltage regulators (VRs) 409. Voltage regulators 406 and 408 provide power to components in Socket 0 and Socket 1, respectively. Socket 0 includes a System on a Chip (SoC) CPU 410 (SoC 0) and GPUs 412 and 414 (GPU 0 and GPU1) with respective registers 413 and 415. Socket 1 includes an SoC CPU 416 (SoC 1), and GPUs 418, and 420 (GPU 2 and GPU 3) with respective registers 419 and 421. SoC CPU 410 includes a power control unit 422 (PCU 0) and Root Ports (RP) 423 and 425, while SoC CPU 416 includes a PCU 424 (PCU 1) and root ports 427 and 429. Fans 426 are used to cool the SoC CPUs and the GPUs in Socket 0 and Socket 1, as well as other platform components.

In addition to the power and socket components, platform 400 includes memory 428 coupled to one or more memory controllers on SoC 0 and memory 430 coupled to one or more memory controllers on SoC 1. Firmware (aka BIOS) for the platform is stored in a firmware storage device 432. A Network Interface Controller (NIC) or Host Fabric Interface (HFI) 434 is coupled to a network or fabric 436. Storage 438 represents one or more storage devices such as a solid-state drive (SSD) or other type of non-volatile storage device. A block 440 represents other components on platform 400, such as a BMC, zero or more peripheral devices, etc. Generally, all or a portion of software 442 may be stored in storage 438 or may be loaded via network/fabric 436.

Power monitor sensor 404 is configured to sense the power drawn from PSU 402 (e.g., using a sense resistor or other well-known mechanism) and send a corresponding analog signal 444 to voltage regulator 406. In the illustrated embodiment, voltage regulator 406 is connected to PCU 422 via an SVID (Serial Voltage Identification) interface 446 that is used to send a digital power consumption value to PCU 422 indicating a level of power being consumed by the platform. Optionally, an over current protection signal may be sent from voltage regulator 406 over SVID interface 446 to PCU 422.

In one embodiment, platform BIOS/firmware is used to enable power balancing. For example, in some embodiments platform 400 includes UEFI (Unified Extensible Firmware Interface) firmware that includes a UEFI component for enabling power balancing and performing associated platform configuration operations.

In one embodiment of a multi-socket platform, one of the SoC CPUs is used to manage frequency control of the components in its own socket plus the other sockets. In platform 400 this is done by SoC 0. PCU 0 calculated frequency limits and sends associated control signals (e.g., messages) to PCU 1 via a socket-to-socket interconnect 448. The control signals/messages may be used to implement two schemes. Under a first scheme, PCU 0 sends both the ‘Power Violation Index’ data and ‘Scaling Weights’ to be implemented for each of the components on SoC 1 (e.g., the socket's CPU/SoC and GPUs 2 and 3) to PCU 1. The frequency of memory 430 may also be adjusted. The ‘Power Violation Index’ data and an applicable ‘Scaling Weight’ is provided to each component to be used for power balancing in Socket 1, and those components adjust their maximum operation frequency.

Under a second scheme, PCU 0 only sends the ‘Power Violation Index’ to PCU 1. The CPU for SoC 1 determines applicable ‘Scaling Weights’ via execution of its software workload.

Each of PCU 0 and PCU 1 are used to set the frequencies of their respective SoC CPU and, optionally, set the frequencies of the GPUs for their sockets. In one embodiment, this is done by sending a SET_SLOT_POWER_LIMIT message to set a power limit value in a register on the GPU that the GPU reads to set its power limit. For example, as shown in FIG. 4, PCU 1 sends a SET_SLOT_POWER_LIMIT message to set a GPU power limit for GPU 2 in register 419. In one embodiment the Root Port on SoC 0 and SoC 1 coupled to the GPUs include a “SLOT CAPABILITIES” to which a SET_SLOT_POWER_LIMIT message is sent. The Root Port then sends a corresponding SET_POWER_LIMIT message to be written into registers 412, 415, 419, and 421 on GPUs 0, 1, 2, and 3, over a PCIe link connecting each GPU to the SoC CPU for its socket.

Under an alterative approach, an SoC CPU for a socket provides the ‘Power Violation Index’ and ‘Scaling Weight’ to the GPUs in its socket. The GPUs then calculate the change in frequency to be effected.

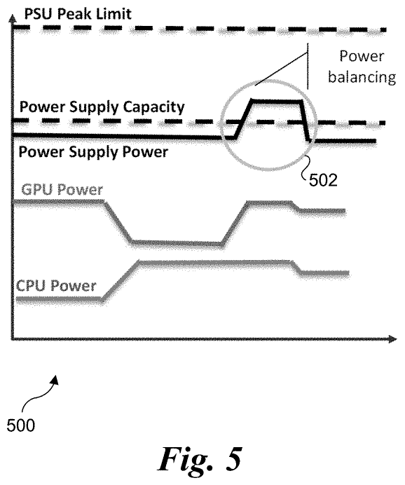

FIG. 5 shows a graph 500 illustrating changes in power levels for GPU and CPU power during runtime operations for platform 400. As shown, during a timeframe 502 the combined power consumption of the GPU power and CPU power (the power supply power) exceeds the power supply capacity. This condition is detected, and corresponding control signals are provided to the GPU(s) and CPU(s) to reduce their frequencies, thus returning the power supply power to a power level that is less than the power supply capacity.

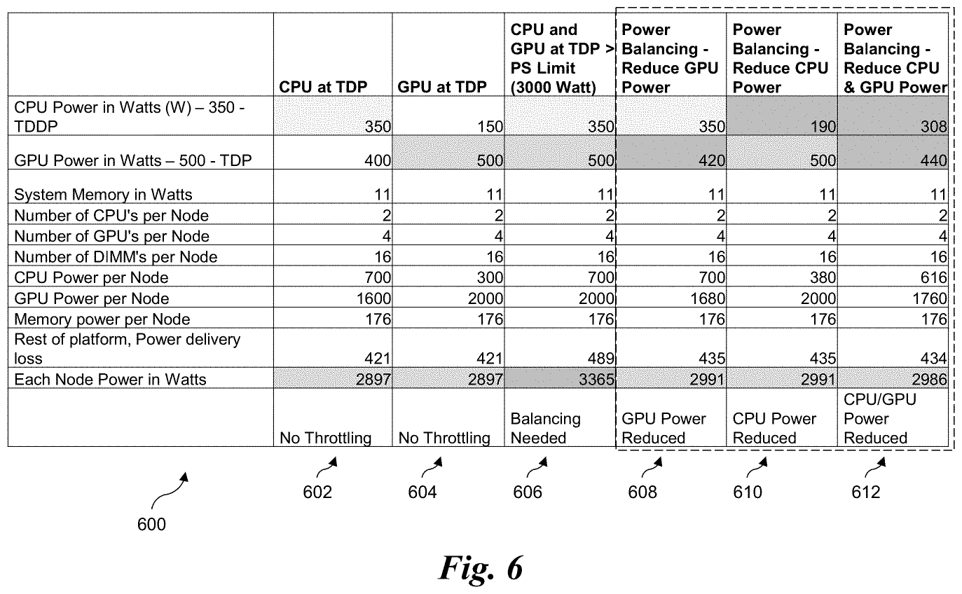

In the foregoing TABLES 1-4, only the CPU and Accelerator frequencies adjustments are shown for simplicity. As shown in table 600 of FIG. 6, in practice the power consumption for the platform is used to determine when power balancing operations are to be performed. In addition to CPU and GPU power consumption, this includes power consumed by memory, which will usually comprise some number of DIMMs (dual inline memory modules), and power consumption for the rest of the platform, and power delivery loss. In this example, there are two CPU's per node, four GPUs per node, and 16 DIMMs per node.

Under a first power configuration 602, the two CPUs are operated at their TDPs of 350 Watts, while the four GPUs are operated at 400 Watts. The power consumption for the node is 2897 Watts, which is less than the 3000-Watt power supply limit. As a result, no throttling is performed. Under a second power configuration 604, the GPUs are operated at 150 Watts and the GPUs are operated at their TDP of 500 Watts. The power consumption for the node is 2897 Watts, and not throttling is performed.

Under a third power configuration 606, the CPUs are operated at TDP (350 Watts) and the GPUs are operated at TDP (500 Watts), resulting in a power consumption for the node of 3365 Watts. This exceeds the 3000-Watt power supply limit, and thus power balancing is needed.

Under a first balanced power configuration 608, the GPU power is reduced to 420 Watts, resulting in the node power consumption of 2991 Watts. Under a second balanced power configuration 610, the CPU power is reduced to 190 Watts, resulting in the node power consumption of 2991 Watts. Under a third balanced power configuration 612, the CPU power is reduced to 308 Watts and the GPU power is reduced to 440 Watts, resulting in the node power consumption of 2986 Watts.

SoC 0 or CPU0 monitors the platform power consumption and periodically updates the ‘Power Violation Index’ to all platform components. In response to receiving a ‘Power Violation Index’ signal or value, a component adjusts its frequency and changes its power consumption. Optionally, an SoC or CPU for a socket may calculate a max. frequency value for all or a portion of the components in the socket for which power management is effected and send or write the max. frequency value to or for those components. This helps in meeting target power limit requirements at a faster response time. In addition, software, depending on workload behavior, can dynamically adjust the ‘Scaling Weight’ for power reduction to each component, thereby extracting maximum node performance. The dynamic adjustment to Scaling parameters can be supplied by the workload as hints in software, or they can be generated based on a learning algorithm which is configured to develop an understanding of the workload phases and adjusts the scaling factors. For example, such a learning algorithm may employ a machine learning (ML) algorithm, such as an ML algorithm employing reinforcement learning. Other types of ML algorithms may also be used.

The techniques described an illustrated for the dual-socket platform of FIG. 4 can be extended to multi-socket platforms having more than two sockets. In this case, SoC 0 or CPU0 will send the ‘Power Violation Index’ to each of the other sockets (e.g., to the PCU in each socket) over a socket-to-socket link in a similar manner illustrated in FIG. 4. As before, either SoC 0 or CPU0 can determining the scaling weights, or these scaling weights can be determined by the CPU executing the software workload for each socket. In cases where the scaling weights are determined by the socket CPU that information

As described above, existing power management schemes, primarily BMC at the node level, have a slow response time (˜100 ms) to balance power between components. This was OK when the main compute element in the node was the CPU and the impact of performance was minimal. With more and more workloads utilizing Accelerators in addition to the CPU, the response time of power balancing by a BMC is too slow and will have an impact on the overall performance of the node. Conversely, the power management scheme implemented in CPU0 to manage the power between CPUs and Accelerators with a much faster response time (˜10× faster), which provides a huge improvement over the current scheme of board and/or rack level power management with minimum impact on performance.

As described above, the operating frequencies of various components are adjusted to reduce power. The adjustment of the operating frequencies is between non-zero values—shutting a component off does not fall within the scope of adjusting its operating frequency as, among other things, the component would no longer be operating.

Example Platform/Compute Node

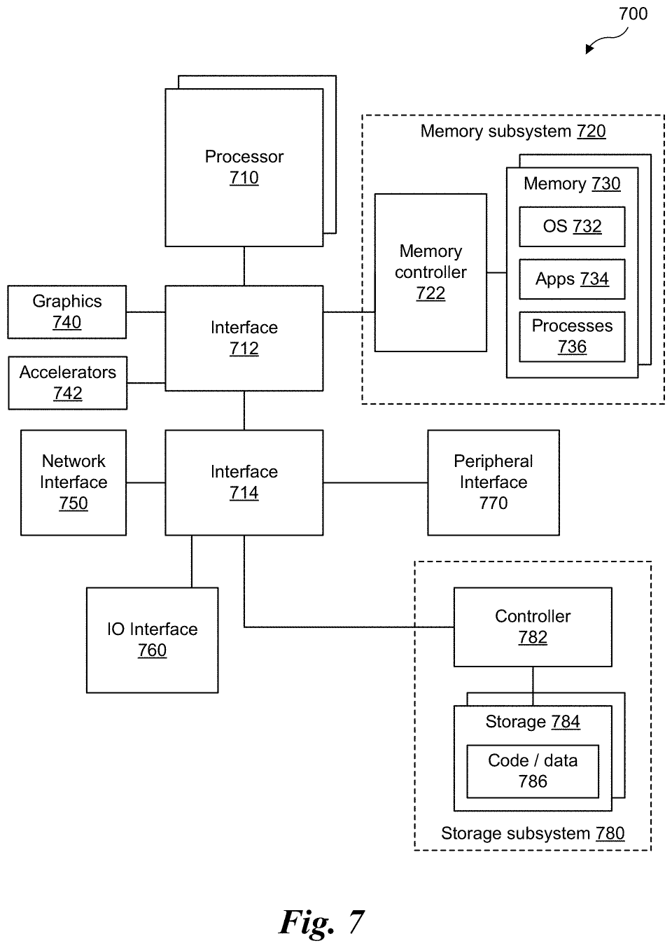

FIG. 7 depicts a platform comprising a compute node 700 in which aspects of the embodiments disclosed above may be implemented. Compute node 700 includes one or more processors 710, which provides processing, operation management, and execution of instructions for compute node 700. Processor 710 can include any type of microprocessor, central processing unit (CPU), graphics processing unit (GPU), processing core, multi-core processor or other processing hardware to provide processing for compute node 700, or a combination of processors. Processor 710 controls the overall operation of compute node 700, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, compute node 700 includes interface 712 coupled to processor 710, which can represent a higher speed interface or a high throughput interface for system components that needs higher bandwidth connections, such as memory subsystem 720 or optional graphics interface components 740, or optional accelerators 742. Interface 712 represents an interface circuit, which can be a standalone component or integrated onto a processor die. Where present, graphics interface 740 interfaces to graphics components for providing a visual display to a user of compute node 700. In one example, graphics interface 740 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 740 generates a display based on data stored in memory 730 or based on operations executed by processor 710 or both. In one example, graphics interface 740 generates a display based on data stored in memory 730 or based on operations executed by processor 710 or both.

In some embodiments, accelerators 742 can be a fixed function offload engine that can be accessed or used by a processor 710. For example, an accelerator among accelerators 742 can provide data compression capability, cryptography services such as public key encryption (PKE), cipher, hash/authentication capabilities, decryption, or other capabilities or services. In some embodiments, in addition or alternatively, an accelerator among accelerators 742 provides field select controller capabilities as described herein. In some cases, accelerators 742 can be integrated into a CPU socket (e.g., a connector to a motherboard or circuit board that includes a CPU and provides an electrical interface with the CPU). For example, accelerators 742 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 742 can provide multiple neural networks, CPUs, processor cores, general purpose graphics processing units, or graphics processing units can be made available for use by AI or ML models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 720 represents the main memory of compute node 700 and provides storage for code to be executed by processor 710, or data values to be used in executing a routine. Memory subsystem 720 can include one or more memory devices 730 such as read-only memory (ROM), flash memory, one or more varieties of random access memory (RAM) such as DRAM, or other memory devices, or a combination of such devices. Memory 730 stores and hosts, among other things, operating system (OS) 732 to provide a software platform for execution of instructions in compute node 700. Additionally, applications 734 can execute on the software platform of OS 732 from memory 730. Applications 734 represent programs that have their own operational logic to perform execution of one or more functions. Processes 736 represent agents or routines that provide auxiliary functions to OS 732 or one or more applications 734 or a combination. OS 732, applications 734, and processes 736 provide software logic to provide functions for compute node 700. In one example, memory subsystem 720 includes memory controller 722, which is a memory controller to generate and issue commands to memory 730. It will be understood that memory controller 722 could be a physical part of processor 710 or a physical part of interface 712. For example, memory controller 722 can be an integrated memory controller, integrated onto a circuit with processor 710.

While not specifically illustrated, it will be understood that compute node 700 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, compute node 700 includes interface 714, which can be coupled to interface 712. In one example, interface 714 represents an interface circuit, which can include standalone components and integrated circuitry. In one example, multiple user interface components or peripheral components, or both, couple to interface 714. Network interface 750 provides compute node 700 the ability to communicate with remote devices (e.g., servers or other computing devices) over one or more networks. Network interface 750 can include an Ethernet adapter, wireless interconnection components, cellular network interconnection components, USB (universal serial bus), or other wired or wireless standards-based or proprietary interfaces. Network interface 750 can transmit data to a device that is in the same data center or rack or a remote device, which can include sending data stored in memory. Network interface 750 can receive data from a remote device, which can include storing received data into memory. Various embodiments can be used in connection with network interface 750, processor 710, and memory subsystem 720.

In one example, compute node 700 includes one or more IO interface(s) 760. IO interface 760 can include one or more interface components through which a user interacts with compute node 700 (e.g., audio, alphanumeric, tactile/touch, or other interfacing). Peripheral interface 770 can include any hardware interface not specifically mentioned above. Peripherals refer generally to devices that connect dependently to compute node 700. A dependent connection is one where compute node 700 provides the software platform or hardware platform or both on which operation executes, and with which a user interacts.

In one example, compute node 700 includes storage subsystem 780 to store data in a nonvolatile manner. In one example, in certain system implementations, at least certain components of storage 780 can overlap with components of memory subsystem 720. Storage subsystem 780 includes storage device(s) 784, which can be or include any conventional medium for storing large amounts of data in a nonvolatile manner, such as one or more magnetic, solid state, or optical based disks, or a combination. Storage 784 holds code or instructions and data 786 in a persistent state (i.e., the value is retained despite interruption of power to compute node 700). Storage 784 can be generically considered to be a “memory,” although memory 730 is typically the executing or operating memory to provide instructions to processor 710. Whereas storage 784 is nonvolatile, memory 730 can include volatile memory (i.e., the value or state of the data is indeterminate if power is interrupted to compute node 700). In one example, storage subsystem 780 includes controller 782 to interface with storage 784. In one example controller 782 is a physical part of interface 714 or processor 710 or can include circuits or logic in both processor 710 and interface 714.

A volatile memory is memory whose state (and therefore the data stored in it) is indeterminate if power is interrupted to the device. Dynamic volatile memory requires refreshing the data stored in the device to maintain state. One example of dynamic volatile memory includes DRAM, or some variant such as Synchronous DRAM (SDRAM). A memory subsystem as described herein may be compatible with a number of memory technologies, such as DDR3 (Double Data Rate version 3, original release by JEDEC (Joint Electronic Device Engineering Council) on Jun. 27, 2007). DDR4 (DDR version 4, initial specification published in September 2012 by JEDEC), DDR4E (DDR version 4), LPDDR3 (Low Power DDR version3, JESD209-3B, August 2013 by JEDEC), LPDDR4) LPDDR version 4, JESD209-4, originally published by JEDEC in August 2014), WIO2 (Wide Input/output version 2, JESD229-2 originally published by JEDEC in August 2014), HBM (High Bandwidth Memory, JESD325, originally published by JEDEC in October 2013, LPDDR3 (currently in discussion by JEDEC), HBM2 (HBM version 2), currently in discussion by JEDEC, or others or combinations of memory technologies, and technologies based on derivatives or extensions of such specifications. The JEDEC standards are available at www.jedec.org.

A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), NVM devices that use chalcogenide phase change material (for example, chalcogenide glass), resistive memory including metal oxide base, oxygen vacancy base and Conductive Bridge Random Access Memory (CB-RAM), nanowire memory, ferroelectric random access memory (FeRAM, FRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

A power source (not depicted) provides power to the components of compute node 700. More specifically, power source typically interfaces to one or multiple power supplies in compute node 700 to provide power to the components of compute node 700. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, compute node 700 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), quick UDP Internet Connections (QUIC), RDMA over Converged Ethernet (RoCE), Peripheral Component Interconnect express (PCIe), Intel® QuickPath Interconnect (QPI), Intel® Ultra Path Interconnect (UPI), Intel® On-Chip System Fabric (IOSF), Omnipath, Compute Express Link (CXL), HyperTransport, high-speed fabric, NVLink, Advanced Microcontroller Bus Architecture (AMBA) interconnect, OpenCAPI, Gen-Z, Cache Coherent Interconnect for Accelerators (CCIX), 3GPP Long Term Evolution (LTE) (4G), 3GPP 5G, and variations thereof. Data can be copied or stored to virtualized storage nodes using a protocol such as NVMe over Fabrics (NVMe-oF) or NVMe.

Although some embodiments have been described in reference to particular implementations, other implementations are possible according to some embodiments. Additionally, the arrangement and/or order of elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other. Additionally, “communicatively coupled” means that two or more elements that may or may not be in direct contact with each other, are enabled to communicate with each other. For example, if component A is connected to component B, which in turn is connected to component C, component A may be communicatively coupled to component C using component B as an intermediary component.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As discussed above, various aspects of the embodiments herein may be facilitated by corresponding software and/or firmware components and applications, such as software and/or firmware executed by an embedded processor or the like. Thus, embodiments of this invention may be used as or to support a software program, software modules, firmware, and/or distributed software executed upon some form of processor, processing core or embedded logic a virtual machine running on a processor or core or otherwise implemented or realized upon or within a non-transitory computer-readable or machine-readable storage medium. A non-transitory computer-readable or machine-readable storage medium includes any mechanism for storing or transmitting information in a form readable by a machine (e.g., a computer). For example, a non-transitory computer-readable or machine-readable storage medium includes any mechanism that provides (i.e., stores and/or transmits) information in a form accessible by a computer or computing machine (e.g., computing device, electronic system, etc.), such as recordable/non-recordable media (e.g., read only memory (ROM), random access memory (RAM), magnetic disk storage media, optical storage media, flash memory devices, etc.). The content may be directly executable (“object” or “executable” form), source code, or difference code (“delta” or “patch” code). A non-transitory computer-readable or machine-readable storage medium may also include a storage or database from which content can be downloaded. The non-transitory computer-readable or machine-readable storage medium may also include a device or product having content stored thereon at a time of sale or delivery. Thus, delivering a device with stored content, or offering content for download over a communication medium may be understood as providing an article of manufacture comprising a non-transitory computer-readable or machine-readable storage medium with such content described herein.

Various components referred to above as processes, servers, or tools described herein may be a means for performing the functions described. The operations and functions performed by various components described herein may be implemented by software running on a processing element, via embedded hardware or the like, or any combination of hardware and software. Such components may be implemented as software modules, hardware modules, special-purpose hardware (e.g., application specific hardware, ASICs, DSPs, etc.), embedded controllers, hardwired circuitry, hardware logic, etc. Software content (e.g., data, instructions, configuration information, etc.) may be provided via an article of manufacture including non-transitory computer-readable or machine-readable storage medium, which provides content that represents instructions that can be executed. The content may result in a computer performing various functions/operations described herein.

As used herein, a list of items joined by the term “at least one of” can mean any combination of the listed terms. For example, the phrase “at least one of A, B or C” can mean A; B; C; A and B; A and C; B and C; or A, B and C.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

What is claimed is:

1. A method for balancing power on a compute platform including one or more processing units and a plurality of variable frequency components, comprising:
monitoring power consumption of the compute platform;
based on the power consumption of the compute platform,
adjusting operating frequencies of at least one of,
the one or more processing units; and
the plurality of variable frequency components,
to reduce the power consumption of the compute platform.

2. The method of claim 1, wherein the compute platform includes a power supply having an associated power supply capacity threshold, further comprising:
detecting the power consumption for the compute platform has exceeded the associated power supply capacity threshold; and
adjusting the operating frequencies of the at least one of the one or more processing units and the plurality of variable frequency components to reduce the power consumption for the compute platform such that the power consumption is below the associated power supply capacity threshold.

3. The method of claim 1, wherein the platform includes a power supply unit (PSU), and the monitoring of the power is performed by a sensor that senses a power level drawn from the PSU.

4. The method of claim 3, further comprising:
providing power limit biasing hints to at least a portion of the one or more processing units and the plurality of variable frequency components;
calculating a power violation index as a function of the platform's current power consumption and a PSU capability limit;
sending the power violation index to the at least a portion of the one or more processing units and the plurality of variable frequency components; and
adjusting the operating frequencies of the at least one of the one or more processing units and the plurality of variable frequency components as a function of the power limit biasing hint provided to a processing unit or variable frequency component and the power violation index.

5. The method of claim 4, wherein the power limit biasing hints comprise scaling weights that are dynamically adjusted during platform runtime operations to effect a power prioritization scheme.

6. The method of claim 1, wherein the compute platform is a multi-socket platform including a central processing unit (CPU) per socket, and each socket includes multiple variable frequency components.

7. The method of claim 6, further comprising:
employing a first CPU for a first socket to manage power consumption of the first CPU and variable frequency components for the first socket and a CPU and variable frequency components for each socket other than the first socket in the multi-socket platform;
determining, via the first CPU, power balancing to be implemented to reduce a power consumption level for the platform; and
sending control signals or messages from the first CPU to each CPU for each socket other than the first socket to effect the power balancing, the control signals or messages conveying information to be employed for adjusting power consumption for at least one of the CPU and one or more variable frequency components for each socket.

8. The method of claim 7, wherein each socket CPU comprises a System on a Chip (SoC), further comprising:
for one or more of the plurality of sockets,
sending, from the SoC, a power limit message to each of the variable frequency components, wherein the power limit message is used to set a maximum frequency at which a variable frequency component is to be operated.

9. The method of claim 1, wherein the variable frequency components comprise one or more of a Graphic Processor Unit (GPU), a General Purpose GPU (GP-GPU), a Tensor Processing Unit (TPU), a Data Processor Unit (DPU), an Artificial Intelligence (AI) processor, an AI inference unit, a network processor, and a Field Programmable Gate Array (FPGA).

10. A compute platform comprising:
a central processing unit (CPU), coupled to memory and configured to change operating frequency to effect a change in power consumption;
a plurality of variable frequency components, coupled to the CPU, each of the plurality of variable frequency components configured to change operating frequency to effect a change in power consumption;
firmware storage device in which firmware is stored, operatively coupled to the CPU;
a power supply unit (PSU);
a power monitor sensor, configured to sense power drawn from the PSU;
one or more voltage regulators, coupled to the PCU and configured to supply power to the CPU and the plurality of variable frequency components,
wherein the compute platform is configured to:
detect, via the power monitor sensor, a power consumption for the platform; and
adjust operating frequencies of at least one of the CPU and the plurality of variable frequency components to reduce the power consumption of the compute platform.

11. The compute platform of claim 10, wherein the PSU has a capability limit, and wherein the platform is further configured to:
provide power limit biasing hints to at least a portion of the plurality of variable frequency components;
calculate a power violation index as a function of the platform's current power consumption and the PSU capability limit;
send the power violation index or data associated with the power violation index to the at least a portion of the plurality of variable frequency components,
wherein each of the variable frequency components is configured to adjust its operating frequency as a function of the power limit biasing hint and the power violation index.

12. The compute platform of claim 11, further comprising software, stored in a storage device on the compute platform or loaded in memory, wherein the power limit biasing hints comprise scaling weights that are dynamically adjusted during platform runtime operations via execution of the software on the CPU.

13. The compute platform of claim 11, wherein the compute platform is further configured to:
receive, at the CPU, data or a signal indicating a power level being consumed by the compute platform or from which a power level being consumed by the compute platform may be derived;
calculate, at the CPU, the power violation index;
calculate or receive, at the CPU, a power limit biasing hint for the CPU; and
adjust an operating frequency of the CPU as a function of the power violation index and the power limit biasing hint for the CPU.

14. The compute platform of claim 11, wherein the compute platform is further configured to:
determine, via the CPU, power balancing to be implemented to reduce a power consumption level for the platform; and
send control signals or messages from the CPU to itself and to each of the variable frequency components, the control signals or messages conveying information to be employed for adjusting power consumption for at least one of the CPU and one or more of the variable frequency components.

15. The compute platform of claim 14, wherein the variable frequency components comprising processing units with one or more registers, and wherein the compute platform is further configured to:
send control signals or messages from the CPU to at least one GPU; and
update at the at least one GPU, a maximum frequency stored in a register on the GPU.

16. A multi-socket platform comprising:
a plurality of sockets, each socket including,
a central processing unit (CPU), coupled to memory and configured to change operating frequency to effect a change in power consumption;
a plurality of accelerators, coupled to the CPU, each of the plurality of accelerators configured to change operating frequency to effect a change in power consumption;
a firmware storage device in which firmware is stored, operatively coupled at least one socket;
a power supply unit (PSU);
a power monitor sensor, to sense power drawn from the PSU; and
one or more voltage regulators, coupled to the PCU and configured to supply power to the CPUs and accelerators in the plurality of sockets,
wherein the multi-socket platform is configured to:
detect, using an output from the power monitor, a power consumption level for the multi-socket platform; and
adjust operating frequencies of at least one of,
one or more CPUs; and
one or more accelerators,
to reduce the power consumption of the multi-socket platform.

17. The multi-socket platform of claim 16, wherein the PSU has a capability limit, and wherein the multi-socket platform is further configured to:
calculate a power violation index as a function of the platform's current power consumption and the PSU capability limit;
for each socket,
provide power limit biasing hints to the CPU and the plurality of accelerators; and
provide the power violation index or data associated with the power violation index to the CPU and the plurality of accelerators,
wherein the CPU and the plurality of accelerators are configured to adjust their operating frequencies as a function of the power limit biasing hint and the power violation index they are provided with.

18. The multi-socket platform of claim 17, further comprising software, at least one of stored in a storage device on the multi-socket platform or loaded in memory, wherein the power limit biasing hints comprise scaling weights that are dynamically adjusted during platform runtime operations via execution of the software on at least one CPU.

19. The multi-socket platform of claim 16, wherein the threshold is a PSU capability limit, and wherein the multi-socket platform is further configured to:
calculate a power violation index as a function of the platform's current power consumption and the PSU capability limit, the power violation index calculated by a first CPU in a first socket or received by the first CPU;
send data associated with the power violation index from the first CPU to each other CPU in the socket or sockets other than the first socket;
at each socket,
determine, via the CPU, power balancing to be implemented for components in the socket; and
send control signals or messages from the CPU to itself and to at least a portion of the accelerators, the control signals or messages conveying information to be employed for adjusting power consumption for at least one of the CPU and one or more of the accelerators.

20. The multi-socket platform of claim 16, wherein the accelerators comprise one or more of a Graphic Processor Unit (GPU), a General Purpose GPU (GP-GPU), a Tensor Processing Unit (TPU), a Data Processor Unit (DPU), an Artificial Intelligence (AI) processor, an AI inference unit, a network processor, and a Field Programmable Gate Array (FPGA).
